(19) United States
(12) Patent Application Publication
(10) Pub. No.: US 2013/0168910 A1
(43) Pub. Date: Jul. 4, 2013

(54) SUCKING DEVICE FOR VACUUM SUCKING WORKPIECE

(71) Applicants: Fu Tai Hua Industry (Shenzhen) Co., Ltd., ShenZhen City (CN); Hon Hai Precision Industry Co., Ltd., Tu-Cheng (TW)

(72) Inventors: ZHI-GUO SUN, Shenzhen City (CN); JUN-LIN PENG, Shenzhen City (CN); YU-LUN LI, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/627,005

(22) Filed: Sep. 26, 2012

(30) Foreign Application Priority Data
Dec. 29, 2011 (CN) 201110450527.0

(51) Int. Cl. B25B 11/00

(52) U.S. Cl. 269/21

(57) ABSTRACT

A sucking device includes a fixing assembly and a sucking assembly. The sucking assembly includes a matching plate, a first annular sealing member, a second annular sealing member, a vacuum generator, and an air pipe. The matching plate is mounted on the fixing assembly, and includes a profile surface. The profile surface defines at least one air hole. The first annular sealing member is mounted on the profile surface of the matching plate, and surrounds the air hole. The second annular sealing member is mounted on the profile surface of the matching plate, and surrounded by the first annular sealing member. The at least one air hole is located between the first annular sealing member and the second annular sealing member. The vacuum generator is mounted on the fixing assembly. The air pipe communicates the at least one air hole with the vacuum generator.

### BACKGROUND

1. Technical Field

The present disclosure relates to sucking devices, particularly to a sucking device for vacuum sucking a workpiece.

2. Description of Related Art

During a mechanical treatment, such as CNC machining, deburring and polishing, a vacuum sucker connecting with a vacuum device may be used to clamp a workpiece for machining. The vacuum sucker uses a sucking force via the vacuum device for sucking the workpiece. However, the vacuum sucker leaves a small space for sucking the workpiece, which results in a decrease of the sucking intensity. When the workpiece is machined by a machining device machines with a mechanical force, the sucking force may not counter balance the mechanical force. As a result, the finished workpieces may not meet a required standard since the workpieces may not be machined with a required precision.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of a sucking device in a production line.

FIG. 2 is an enlarged, isometric view of the sucking device shown in FIG. 1.

FIG. 3 is a partial, explored view of the sucking device shown in FIG. 1.

### DETAILED DESCRIPTION

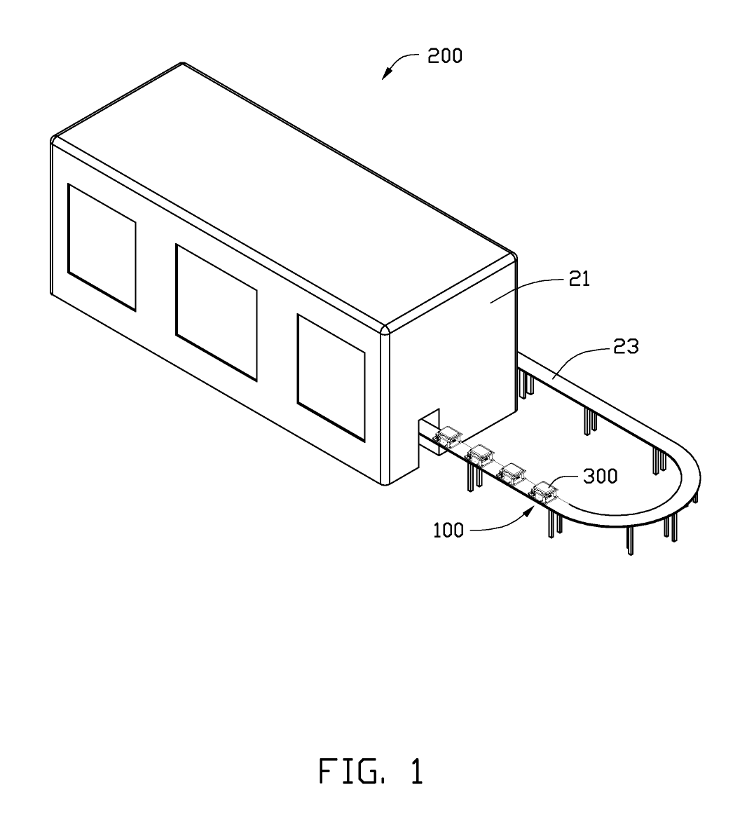

FIG. 1 shows an embodiment of a plurality of sucking devices 100 for sucking a plurality of workpieces 300 in a production line 200, for positioning the workpieces 300 to be machined. The product line 200 includes a machining area 21 and a conveyer belt 23. The sucking devices 100 are separately arranged on the conveyer belt 23. The conveyer belt 23 conveys the workpieces 300 fixed by the sucking devices 100 to the machining area 21 to be machined. In the illustrated embodiment, a deburring device (not shown) and a polishing device (not shown) are set in the machining area 21 for deburring and polishing the workpieces 300, respectively. The workpieces 300 are housings of an electronic device (not shown).

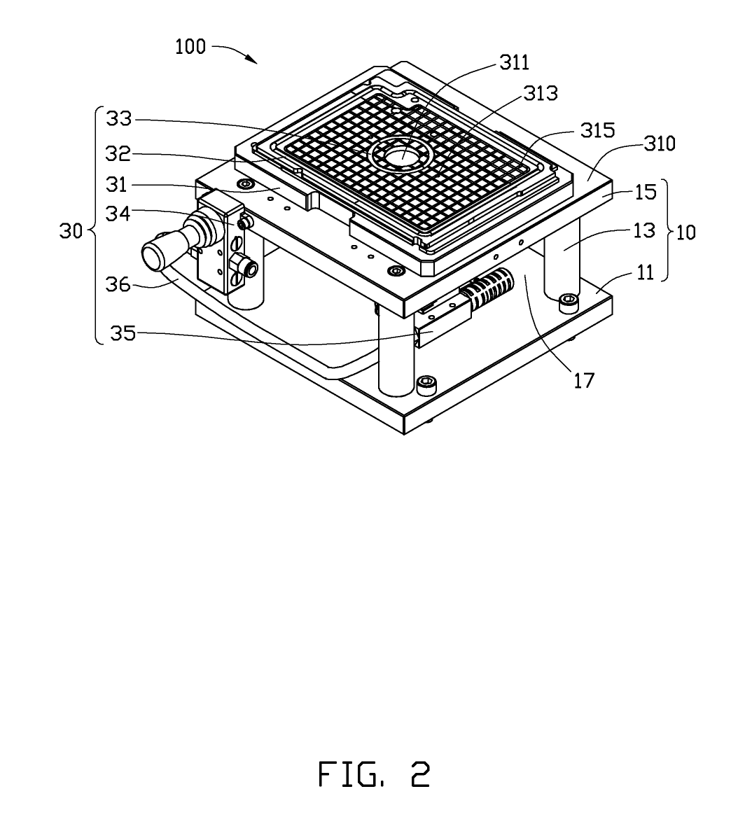

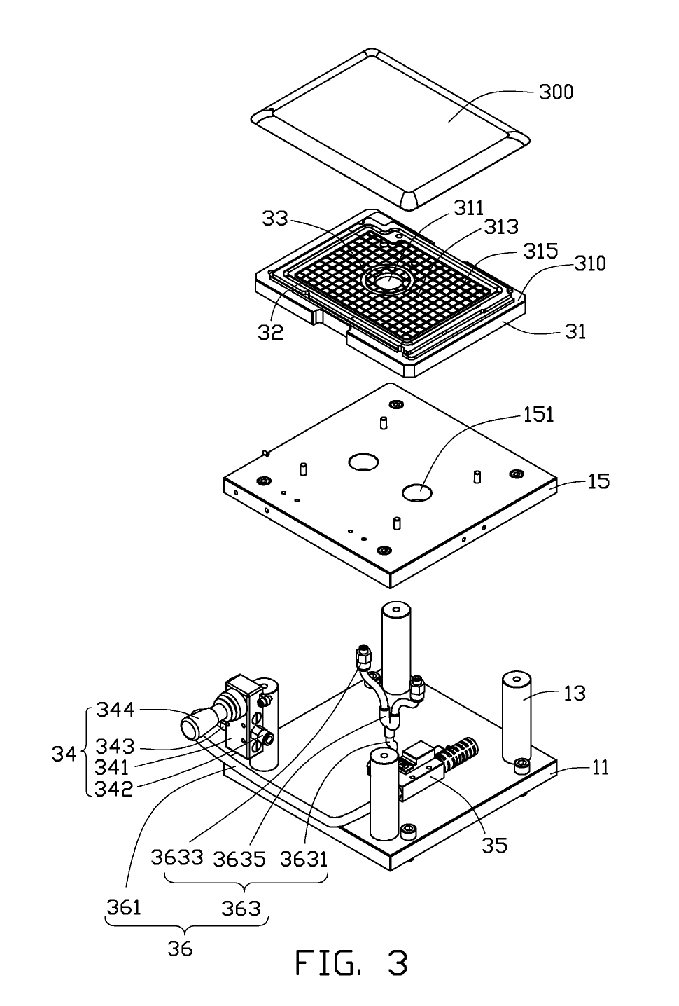

FIGS. 2 and 3 show one of the sucking devices 100 including a fixing assembly 10 and a sucking assembly 30 mounted on the fixing assembly 10. The fixing assembly 10 includes a fixing plate 11, four supporting posts 13, and a mounting plate 15. The supporting posts 13 are mounted on the fixing plate 11. The mounting plate 15 is mounted on the supporting posts 13, and is supported by the supporting posts 13.

The fixing plate 11 is fixed on the conveyer belt 23. The supporting posts 13 are substantially perpendicularly fixed on four corners of the fixing plate 11, for supporting the mounting plate 15. The mounting plate 15 is mounted on top ends of the supporting posts 13. The mounting plate 15 parallels to the fixing plate 11, and defines a receiving space 17 cooperating with the fixing plate 11. The mounting plate 15 defines a pair of first through holes 151 (shown in FIG. 3) communicating with the receiving space 17. In other embodiments, the number of the supporting posts 13 can be three, five or more.

The sucking assembly 30 includes a matching plate 31, a first annular sealing member 32, a second annular sealing member 33, an air controlling member 34, a vacuum generator 35, and an air pipe 36. The matching plate 31 is mounted on the mounting plate 15 at a side away from the fixing plate 11, and parallels to the mounting plate 15. The matching plate 31 includes a profile surface 310 away from the mounting plate 15 to match with each of the workpieces 300, for steadily positioning the workpieces 300. The matching plate 31 is substantially rectangular, and defines a second through hole 311, a pair of air holes 313, and a plurality of scribed grooves 315 at the profile surface 310. The second through hole 311 is substantially located at a center of the profile surface 310. The air holes 313 are located opposite sides of the second through hole 311 and aligns with the first through holes 151, respectively. The scribed grooves 315 interlace with each other, and communicate with the air holes 313. In other embodiments, the number of the air hole 313 can be one, three, or more than three. The second through hole 311 can be omitted.

The first annular sealing member 32 is mounted on the profile surface 310 of the matching plate 31, and is substantially an enclosed shape to encircle the second through hole 311 and the air holes 313. In the illustrated embodiment, the first annular sealing member 32 is substantially a rectangular frame, and is made of silicon materials. In other embodiments, the first annular sealing member 32 can be made by other flexible materials, such as rubber, for example.

The second annular sealing member 33 is mounted on the profile surface 310 of the matching plate 31. An enclosed area of the second annular sealing member 33 is located in the first annular sealing member 32. The second annular sealing member 33 surrounds the second through hole 311 without surrounding the air holes 313. In the illustrated embodiment, the second annular sealing member 33 is substantially a ring, and is made of silicon material. In other embodiments, the second annular sealing member 33 can be made by other flexible materials, such as rubber, for example.

The air controlling member 34 is mounted on a sidewall of the mounting plate 15, and includes a main body 341 mounted on the mounting plate 15, and a switch 344 mounted on a sidewall of the main body 341 away from the mounting plate 15. The main body 341 defines an air inlet 342 and an air outlet 343 at opposite sidewalls. The air inlet 342 communicates with the air outlet 343, and the switch can be processed to control the air flow between the air inlet 342 and the air outlet 343 in a manual way.

The vacuum generator 35 is mounted on the fixing plate 11, and received in the receiving space 17. The air pipe 36 includes a first pipe portion 361 and a second pipe portion 363. The first pipe portion 361 connects the air outlet 343 with the vacuum generator 35, for transmitting air from the switch 344 to the vacuum generator 35. The second pipe portion 363 includes a main pipe 3631, a pair of branch pipes 3633, and a Y-joint 3635 connected the main pipe 3631 and the branch pipes 3633. The main pipe 3631 and the Y-joint 3635 communicate the vacuum generator 35 with the branch pipes 3633 cooperatively. A distal end of each of the pair of branch pipes 3633 communicates with the corresponding air hole 313.

In assembly, the fixing plate 11 is fixed on the conveyer belt 23, and the supporting posts 13 are mounted on the fixing plate 11. The mounting plate 15 is mounted on the supporting posts 13, and the matching plate 31 is mounted on the mounting plate 15 at a side away from the fixing plate 11. The first annular sealing member 32 and the second annular sealing member 33 are mounted on the profile surface 310. The air controlling member 34 is mounted on a sidewall of the mounting plate 15, and the vacuum generator 35 is mounted on the fixing plate 11. The first pipe portion 361 connects the air outlet 343 with the vacuum generator 35. The second pipe portion 363 connects the vacuum generator 35 with the air holes 313.

In use, air is input from the air inlet 342. One of the workpieces 300 is position on the profile surface 310 of the matching plate 31, and covers the first annular sealing member 32 and the second annular sealing member 33. The workpiece 300, the matching plate 31, the first annular sealing member 32, and the second annular sealing member 33 cooperatively define a sealing chamber (not shown). The scribed grooves 315 are for enlarging the space of the sealing chamber. The switch 344 is switched on, and the air is transmitted to the vacuum generator 35 via the air outlet 343 and the first pipe portion 361. The vacuum generator 35 forms a whirling airflow, to allow the air in the sealing chamber to be sucked into the second pipe portion 363 via the air holes 313. Because the first annular sealing member 32 and the second annular sealing member 33 prevent air to from entering the sealing chamber, the outer atmospheric pressure is larger than the air pressure of the first annular sealing member 32, thus the workpiece 300 is sucked on the sucking devices 100 steadily. The conveyer belt 23 conveys the sucking devices 100 bearing with the workpieces 300 to the machining area 21, for machining the workpieces 300.

In other embodiments, the fixing assembly 10 can be replaced by other mounting structures, such as a platform, for example, and the air pipe 36 passes through the platform to communicate with the air holes 313.

Because a sucking area of each of the sucking devices 100 to each of the workpieces 300 is decided by the an area between the first annular sealing member 32 and the second annular sealing member 33, the sucking area can be designed to a suitable area for steadily sucking each of the workpieces 300. When the workpieces 300 are machined, the sucking force is strong enough to counter balance the machining force of a machining device.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A sucking device, comprising:
a fixing assembly; and
a sucking assembly comprising:
a matching plate mounted on the fixing assembly, comprising a profile surface, the profile surface defining at least one air hole;
a first annular sealing member mounted on the profile surface of the matching plate, and surrounding to the air hole;
a second annular sealing member mounted on the profile surface of the matching plate, in the first annular sealing member, the at least one air hole being between the first annular sealing member and the second annular sealing member;
a vacuum generator mounted on the fixing assembly; and
an air pipe communicating the at least one air hole with the vacuum generator.

2. The sucking device of claim 1, wherein the first annular sealing member and the second annular sealing member are made of flexible materials.

3. The sucking device of claim 1, wherein the profile surface is configured to form a profile matching with a profile of a workpiece, and to position the workpiece.

4. The sucking device of claim 1, wherein the profile surface defines a plurality of scribed grooves interlacing with each other.

5. The sucking device of claim 4, wherein the plurality of scribed grooves are interconnected with the at least one air hole.

6. The sucking device of claim 1, wherein the sucking assembly further comprises an air controlling member communicating with the air pipe, the air controlling member is adapted to control air flows through the air pipe.

7. The sucking device of claim 6, wherein the air controlling member comprise a main body and a switch mounted on the main body, the main body defines an air inlet and an air outlet communicating with the air inlet, the switch is adapted to control the air flows through the air pipe.

8. The sucking device of claim 1, wherein the number of the at least one air hole is two, the air pipe branches into two branch pipes at a Y-joint, each of the two branch pipes communicates with each of the at least one air hole.

9. The sucking device of claim 1, wherein the fixing assembly comprises a fixing plate, a plurality of supporting posts, and a mounting plate, the plurality of supporting posts are perpendicularly fixed on the fixing plate, the mounting plate is mounted on the plurality of supporting posts, the mounting plate is parallel to the fixing plate, the matching plate is mounted on a side of the mounting plate away from the fixing plate, the vacuum generator is mounted on the fixing plate.

10. The sucking device of claim 9, wherein the mounting plate defines at least one first through hole communicating with the at least one air hole.

11. A sucking device, for sucking a workpiece, comprising:
a fixing assembly; and
a sucking assembly comprising:
a matching plate mounted on the fixing assembly, and defining at least one air hole;
a first annular sealing member mounted on the matching plate;
a second annular sealing member mounted on the matching plate, and surrounded by the first annular sealing member, the at least one air hole being between the first annular sealing member and the second annular sealing member;
a vacuum generator mounted on the fixing assembly; and
an air pipe communicating the at least one air hole with the vacuum generator;
wherein the first annular sealing member and the second annular sealing member are configured to be covered by a workpiece; and the workpiece, the matching plate, the first annular sealing member, and the second annular sealing member cooperatively define a sealing chamber; the vacuum generator vacuum the sealing chamber to provide a sucking force to suck the workpiece.

12. The sucking device of claim 11, wherein the first annular sealing member and the second annular sealing member are made of flexible materials.

13. The sucking device of claim 11, wherein the matching plate is configured to form a profile surface, away from the fixing assembly, matching with a profile of the workpiece, and to position the workpiece.

14. The sucking device of claim 13, wherein the profile surface defines a plurality of scribed grooves interlacing with each other.

15. The sucking device of claim 14, wherein the plurality of scribed grooves communicate with the at least one air hole.

16. The sucking device of claim 11, wherein the sucking assembly further comprises an air controlling member communicating with the air pipe, the air controlling member is adapted to control air flows through the air pipe.

17. The sucking device of claim 16, wherein the air controlling member comprise a main body and a switch mounted on the main body, the main body defines an air inlet and an air outlet communicating with the air inlet, the switch is adapted to control the air flows through the air pipe.

18. The sucking device of claim 11, wherein the number of the at least one air hole is two, the air pipe branches into two branch pipes at a Y-joint, each of the two branch pipes communicate with each of the at least one air hole.

19. The sucking device of claim 11, wherein the fixing assembly comprises a fixing plate, a plurality of supporting posts, and a mounting plate, the plurality of supporting posts are perpendicularly fixed on the fixing plate, the mounting plate is mounted on the plurality of supporting posts, the mounting plate is parallel to the fixing plate, the matching plate is mounted on a side of the mounting plate away from the fixing plate, the vacuum generator is mounted on the fixing plate.

20. The sucking device of claim 19, wherein the mounting plate defines at least one first through hole communicating with the at least one air hole.
